(19) United States
(12) Patent Application Publication
(10) Pub. No.: US 2023/0351220 A1
(43) Pub. Date: Nov. 2, 2023

(54) PREDICTION MODEL MANAGEMENT

(71) Applicant: Lemon Inc., Grand Cayman (KY)

(72) Inventors: Meng XIN, Los Angeles, CA (US); Silun WANG, Los Angeles, CA (US); Yu ZHANG, Los Angeles, CA (US)

(21) Appl. No.: 18/219,158

(22) Filed: Jul. 7, 2023

(51) Int. Cl. G06N 5/022

(52) U.S. Cl. CPC G06N 5/022

(57) ABSTRACT

There are proposed methods, devices, and computer program products for prediction model management. In the method, gradient information associated with the prediction model is obtained based on sample data for a time slot in a predetermined time period. An offset of the time slot in the predetermined time period is acquired. A step size is determined for updating a parameter of the prediction model based on the gradient information, the offset, and historical gradient information that is determined based on historical sample data for a group of historical time slots before the time slot. With these implementations, the whole training procedure may be divided into multiple time period and each time period may further include multiple time slots. During each time period, the offset may be used to control the importance of the historical gradient information and the gradient information in determining the step size.

### FIELD

The present disclosure generally relates to prediction model management, and more specifically, to methods, devices and computer program products for prediction model management based on a periodic reset during a training procedure.

### BACKGROUND

Nowadays, the machine learning technique has been widely used in data processing. For example, in a recommendation environment, objects such as an article, an advertisement, a message, an audio, a video, a game and so on may be provided to users. Then, the users may subscript a channel in which the article is provided, buy a product that is recommended in the advertisement, and so on. At this point, events (such as a subscripting event, a buying event, and the like) between the user and corresponding objects may be detected. There have been proposed solutions for training a prediction model with sample data associated with the users, the objects, and the events, and then the prediction model may be used for outputting a trend of events between users and the objects in the future. However, the prediction model is gradually trained by historical data that covers a long time duration and cannot accurately reflect recent data distributions in the training data. At this point, how to make the prediction model learn knowledges from the most recent data becomes a hot focus.

### SUMMARY

In a first aspect of the present disclosure, there is provided a method for managing a prediction model. In the method, gradient information associated with the prediction model is obtained based on sample data for a time slot in a predetermined time period. An offset of the time slot in the predetermined time period is acquired. A step size is determined for updating a parameter of the prediction model based on the gradient information, the offset, and historical gradient information that is determined based on historical sample data for a group of historical time slots before the time slot.

In a second aspect of the present disclosure, there is provided an electronic device. The electronic device comprises: a computer processor coupled to a computer-readable memory unit, the memory unit comprising instructions that when executed by the computer processor implements a method according to the first aspect of the present disclosure.

In a third aspect of the present disclosure, there is provided a computer program product, the computer program product comprising a computer readable storage medium having program instructions embodied therewith, the program instructions executable by an electronic device to cause the electronic device to perform a method according to the first aspect of the present disclosure.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE SEVERAL VIEWS OF THE DRAWINGS

Through the more detailed description of some implementations of the present disclosure in the accompanying drawings, the above and other objects, features and advantages of the present disclosure will become more apparent, wherein the same reference generally refers to the same components in the implementations of the present disclosure.

FIG. 1 illustrates an example environment for prediction model management according to the machine learning technique;

FIG. 2 illustrates an example diagram of sample data for various time slots in a predetermined time period according to implementations of the present disclosure;

FIG. 3 illustrates an example diagram for managing a prediction model according to implementations of the present disclosure;

FIG. 4 illustrates an example diagram of sample data according to implementations of the present disclosure;

FIG. 5 illustrates an example diagram for determining a step size for updating a parameter of a prediction model according to implementations of the present disclosure;

FIG. 6 illustrates an example flowchart for a method for updating a prediction model according to implementations of the present disclosure;

FIG. 7 illustrates an example flowchart of a method for managing a prediction model according to implementations of the present disclosure; and

FIG. 8 illustrates a block diagram of a computing device in which various implementations of the present disclosure can be implemented.

### DETAILED DESCRIPTION

Principle of the present disclosure will now be described with reference to some implementations. It is to be understood that these implementations are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one implementation,” “an implementation,” “an example implementation,” and the like indicate that the implementation described may include a particular feature, structure, or characteristic, but it is not necessary that every implementation includes the particular feature, structure, or characteristic. Moreover, such phrases are not necessarily referring to the same implementation. Further, when a particular feature, structure, or characteristic is described in connection with an example implementation, it is submitted that it is within the knowledge of one skilled in the art to affect such feature, structure, or characteristic in connection with other implementations whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example implementations. As used herein, the term “and/or” includes any and all combinations of one or more of the listed terms.

The terminology used herein is for the purpose of describing particular implementations only and is not intended to be limiting of example implementations. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

Principle of the present disclosure will now be described with reference to some implementations. It is to be understood that these implementations are described only for the purpose of illustration and help those skilled in the art to understand and implement the present disclosure, without suggesting any limitation as to the scope of the disclosure. The disclosure described herein can be implemented in various manners other than the ones described below. In the following description and claims, unless defined otherwise, all technical and scientific terms used herein have the same meaning as commonly understood by one of ordinary skills in the art to which this disclosure belongs.

It may be understood that data involved in the present technical solution (including but not limited to the data itself, the acquisition or use of the data) should comply with requirements of corresponding laws and regulations and relevant rules.

It may be understood that, before using the technical solutions disclosed in various implementation of the present disclosure, the user should be informed of the type, scope of use, and use scenario of the personal information involved in the present disclosure in an appropriate manner in accordance with relevant laws and regulations, and the user's authorization should be obtained.

For example, in response to receiving an active request from the user, prompt information is sent to the user to explicitly inform the user that the requested operation will need to acquire and use the user's personal information. Therefore, the user may independently choose, according to the prompt information, whether to provide the personal information to software or hardware such as electronic devices, applications, servers, or storage media that perform operations of the technical solutions of the present disclosure.

As an optional but non-limiting implementation, in response to receiving an active request from the user, the way of sending prompt information to the user, for example, may include a pop-up window, and the prompt information may be presented in the form of text in the pop-up window. In addition, the pop-up window may also carry a selection control for the user to choose “agree” or “disagree” to provide the personal information to the electronic device.

It may be understood that the above process of notifying and obtaining the user authorization is only illustrative and does not limit the implementation of the present disclosure. Other methods that satisfy relevant laws and regulations are also applicable to the implementation of the present disclosure.

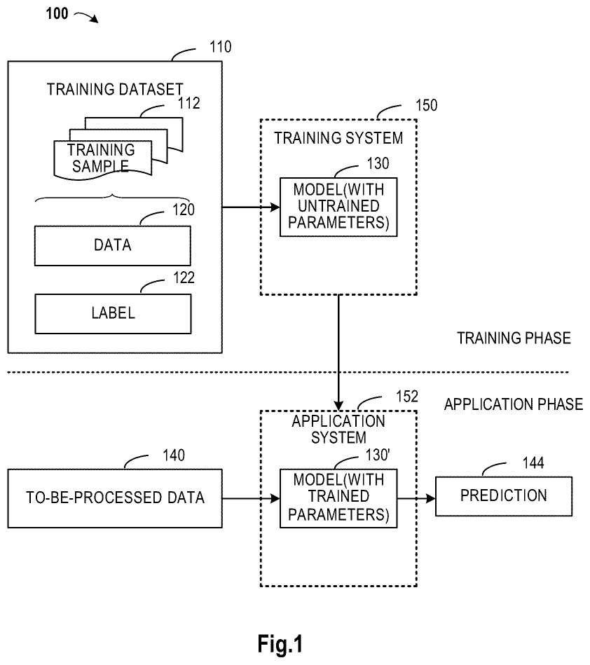

For the purpose of description, the following paragraphs will provide more details by taking a recommendation system as an example environment. In the recommendation system, various objects (such as an article, an advertisement, a message, an audio, a video, a game and so on) may be sent to the user. Sometimes, the user is interested in the object and then performs a subscription or place an order. If the user is not interested in the object, he/she may pass the object and do nothing. By now, solutions have been provided for generating a prediction model for predicting events related to the user and object in the future. Hereinafter, reference will be made to FIG. 1 for more details about the prediction model, here FIG. 1 illustrates an example environment for prediction model management according to the machine learning technique.

In FIG. 1, a model 130 may be provided for the event prediction. Here, the environment 100 includes a training system 150 and an application system 152. The upper portion of FIG. 1 shows a training procedure, and the lower portion shows an application procedure. Before the training procedure, the model 130 may be configured with untrained or partly trained parameters (such as initial parameters, or pre-trained parameters). In the training procedure, the model 130 may be trained in the training system 150 based on a training dataset 110 including a plurality of training samples 112. Here, each training sample 112 may have a two-tuple format, and may include data 120 (for example, data associated with the user and the object) and a label 122 for the event. Specifically, a large amount of training sample 112 may be used to implement the training procedure iteratively. After the training procedure, the parameters of the model 130 may be updated and optimized, and a model 130′ with trained parameters may be obtained. At this point, the model 130′ may be used to implement the prediction task in the application procedure. For example, the to-be-processed data 140 may be inputted into the application system 152, and then a corresponding prediction 144 may be outputted.

In FIG. 1, the model training system 150 and the model application system 152 may include any computing system with computing capabilities, such as various computing devices/systems, terminal devices, servers, and so on. The terminal device may involve any type of mobile device, fixed terminal, or portable device, including mobile phones, desktop computers, laptop computers, notebook computers, netbook computers, tablet computers, media computers, multimedia tablets, or any combination of the foregoing, including the accessories and peripherals of these devices or any combination thereof. Servers may include but are not limited to mainframes, edge computing nodes, computing devices in cloud environments, and so on. It should be understood that the components and arrangements in the environment 100 in FIG. 1 are only examples, and a computing system suitable for implementing the example implementation described in the present disclosure may include one or more different components, and other components. For example, the training system 150 and the application system 152 may be integrated in the same system or device.

As illustrated in FIG. 1, the training dataset 110 may include historical training sample 112 collected from data logs of the recommendation system according to requirements of corresponding laws and regulations and relevant rules. However, the performance of the model 130′ is closely associated with whether features (such as embeddings) of the training sample 112 may correctly reflect various aspects of the training sample 112.

Multiple solutions have been proposed for training the model 130 with the historical training dataset 110. For example, a loss between the label 122 and a prediction of the label 122 determined from the model 130 and the data 120 may be determined. Further, gradient information may be determined based on the loss and then the parameter of the model 130 may be updated based on the gradient information. As the time goes, the model gradually obtains knowledge about the event during a long time duration. However, in the recommendation system, usually the objects change quickly. For example, the object may be advertisements related to various camera products, and product development cycles are short and new camera products are developed rapidly. At this point, compared with the knowledge about the recent camera products, knowledge about the old and outdated camera products is not important anymore. At this point, it is desired to learn more knowledge about recent camera products in a faster and effective way.

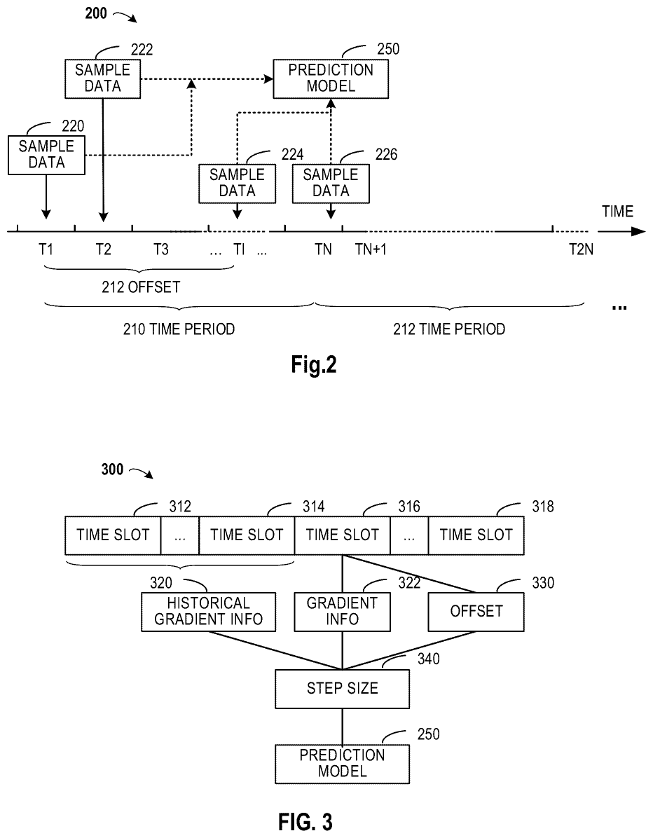

In view of the above, the present disclosure proposes a prediction model management solution based on a periodic reset during the training procedure. Specifically, a whole time duration of the training procedure may be divided into multiple time periods (for example, a time period may have a length of a day, a week and the like). Reference will be made to FIG. 2 for sample data that is collected during the training procedure, here FIG. 2 illustrates an example diagram 200 of sample data for various time slots in a predetermined time period according to implementations of the present disclosure. As illustrated in FIG. 2, the whole train duration may be divided into a time period 210, a time period 212, and the like, and multiple sample data 220, 222, . . . , 224, . . . , and 226 may be collected within the time period 210.

The time period 210 may have a predetermined duration, for example, the time period 210 may include one day and the time period 210 may be divided into multiple time slots. For example, sample data 220 may be collected from a time slot T₁, sample data 222 may be collected from a time slot T₂, . . . , sample data 224 may be collected from a time slot Tᵢ, . . . , sample data 226 may be collected from a time slot Tₙ. Here, the time period 210 may be divided into, for example, 24 time slots and thus each of the time slot may cover a time length of one hour. Alternatively and/or in addition, the time period and/or the time slot may have time lengths different from the above examples.

In the context of the present disclosure, the sample data 220, 222, . . . , 224, . . . , and 226 may be used for training a prediction model 250. A corresponding offset may be determined for each time slot, and then the offset is considered during the training procedure. For example, regarding the time slot Tᵢ, an offset 212 may be determined and then the offset 212 is used in determining the step size for updating parameter(s) of the prediction model 250. In implementations of the present disclosure, more or less sample data may be collected within each time slot. It is to be understood that FIG. 2 only shows examples of the sample data within the time period 210, the time period 212 may have a similar structure and more or less sample data may be collected within the time period 212.

Hereinafter, referring to FIG. 3 for more details about the prediction model management, here FIG. 3 illustrates an example diagram 300 for managing the prediction model 250 according to implementations of the present disclosure. As illustrated in FIG. 3, each time duration may be equally divided into time slots 312, . . . , 314, 316, . . . , and 318, and gradient information associated with the prediction model 250 may be obtained based on sample data for each time slot in the predetermined time period. For example, gradient information 322 may be obtained for the time slot 316. Then, an offset 330 of the time slot 316 in the predetermined time period may be acquired. Further, a step size 340 may be determined for updating the parameter(s) of the prediction model 250 based on the gradient information 322, the offset 330, and historical gradient information 320 that is determined based on historical sample data for a group of historical time slots before the time slot. As illustrated in FIG. 3, the historical gradient information 320 for the time slot 316 may be determined based on historical sample data for time slots 312, . . . , and 314. Further, the step size 340 may be used to update the parameter(s) of the prediction model 250.

With implementations of the present disclosure, the offset for each time slot may be considered in determining the step size, and thus the step size may be periodically reset in each predetermined time period. In this way, the offset may be used to control the importance of the historical gradient information 320 and the gradient information 322. For example, at the beginning of each time period (i.e., when the current time slot is the first one in the time period), the historical gradient information may be omitted and only the gradient information for the current time slot is considered in determining the step size 340. In this way, more knowledge is learned from the recent sample data in a faster and effective way.

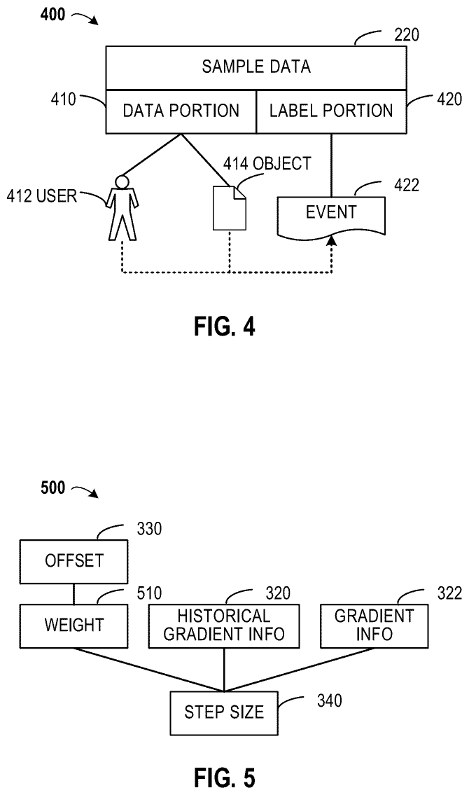

Having provided a general description of the solution, the following paragraphs will provide more details about the prediction model management. In implementations of the present disclosure, corresponding gradient information may be determined from each sample data. Referring to FIG. 4 for details about the sample data, here FIG. 4 illustrates an example diagram 400 of sample data according to implementations of the present disclosure. As illustrated in FIG. 4, the sample data 220 may include two portions: a data portion 410 may represent features related to a user 412 and an object 414; and a label portion 420 may represent an event 422 between the user 412 and the object 414.

It is to be understood that all the information about the user, the data and the events do not include any sensitive information. For example, all the information may be collected according to requirements of corresponding laws and regulations and relevant rules, and then may be converted into an invisible format (such as embeddings) for the protection purpose. In the context of the present disclosure, the event 422 may include multiple types, for example, a click event and/or a conversion event.

In the context of the present disclosure, the object 414 (such as an advertisement, a message, an audio, a video, a game and so on) may be provided to the user 412. Then the user 412 may click and open the object 414, at this point, a click event is detected. In another example, the conversion event here may indicate that the user behavior is converted towards a deeper interaction with the recommendation system. Usually, a conversion rate (CVR) is a key factor for measure whether the object 414 attracts the user's attention. Here, the conversion event may comprise a subscription event, an order event, a download event, an adding-to-bag event, a following event, or a comment event, the conversion event occurs after the click event. In an online shopping environment, the conversion event may comprise an order event, an adding-to-bag event, and the like. In a multimedia service environment, the conversion event may comprise a download event, and the like. With these implementations, the sample data may include rich information about the event between the user and the object. Therefore, the prediction model 250 may learn rich knowledge from the sample data and then provide an accurate prediction for the event in the future.

In implementations of the present disclosure, in order to obtain the gradient information, a prediction may be obtained for the label portion 420 in the sample data 220 based on the data portion 410 in the sample data 220 according to the prediction model 250. Specifically, the data portion 410 may be inputted into the prediction model 250, and then the prediction model 250 may output the prediction for the label portion 420 based on current parameter(s) of the prediction model 250. A loss may be determined between the prediction for the label portion 420 and the label portion 420 based on a predetermined loss function. At this point, the gradient information may be acquired based on a gradient of the loss and the parameter of the prediction model 250. Specifically, the gradient information gₜ for the time slot t may be determined based on Formula 1 as below:

gₜ=∇_{W}J(Wₜ)+α·Wₜ Formula 1

In the above formula 1, gₜ represents the gradient information for the time slot t, Wₜ represents the parameter(s) of the prediction model at the time slot t, J( ) represents the loss function, ∇_{W} represents a gradient operation related to the parameters, and α represents a weight decay coefficient of L2 regularization. It is to be understood that the above Formula 1 is just an example for determining the gradient information for the time slot t. Additional and/or in addition, the Formula 1 may be modified by considering more or less variables in the formula. For example, the weight α may be omitted to simplify the calculation. At this point, the gradient information may be determined in an easy and effective way according to mathematical operations.

In implementations of the present disclosure, the predetermined time period may have a fixed length of one or more days. For example, the time period may be set to one day. In another example, the time period may have a different time length such as two days, or another value. Further, the time period may be determined based on a change frequency of the object. In the recommendation environment, if the object indicates advertisements for camera products, the length of the time period may decrease with the change frequency of the camera products. In other words, if new camera products are developed with a relative long time duration (i.e., a lower change frequency), then the length of the time period may be set to a relative long length; and if new camera products are developed with a relative short time duration (i.e., a higher change frequency), then the length of the time period may be set to a relative short length. With these implementations, the time period may be determined in a flexible and dynamic way, which may be helpful in learning more knowledge about the most recent sample data.

In implementations of the present disclosure, an offset may be acquired for each time slot. Here, the offset may represent a difference between the time slot and the first time slot in the time period. For example, the offset may be measured by the difference between sequence numbers related to the two time slots. Alternatively and/or in addition, the offset may be measured by the time difference between time points for the two time slots. Then, the step size may be determined based on the gradient information, the offset, and historical gradient information associated with the group of historical time slots before the time slot.

Here, the offset may reflect whether the current sample data is the most recent sample data, if the offset equals to zero, it indicates that the current sample data is collected at the beginning of the time period. At this point, the impact of the sample data may be enhanced in updating the prediction model 250 (for example, only the current sample data is considered in determining the step size while the historical sample data is excluded). If the offset does not equal to zero, it indicates that the sample is not collected at the beginning of the time period, and thus both of the current sample data and the historical sample data are considered in determining the step size.

FIG. 5 illustrates an example diagram 500 for determining a step size for updating a parameter of a prediction model according to implementations of the present disclosure. As illustrated in FIG. 5, in order to determine the step size 340, a weight 510 may be determined for the historical gradient information 320 based on the offset 330. For example, the weight 510 may be determined within a predefined area and increases with the offset 330, and then the step size may be generated based on the gradient information, the historical gradient information, and the weight for the historical gradient information. Specifically, the step size may be determined based on the following Formulas 2.1 and 2.2:

Δₜ=ƒ(β·vₜ₋₁gₜ) Formula 2.1

β=ƒ₁(oₜ,area₁) Formula 2.2

In the above Formula 2.1, Δₜ represents the step size for updating the parameter of the prediction model during the time slot t, vₜ₋₁ represents the historical gradient information for the time slot t, which is associated with the group of time slots before the time slot t, gₜ represents the gradient information for the time slot t, β represents the weight for the historical gradient information, and ƒ( ) represents a function associated with the gradient information gₜ, the historical gradient information vₜ₋₁, and the weight β for the historical gradient information.

Further, the weight β may be determined within an area (represented as area₁ such as [0, 1]) based on the offset (represented as oₜ). ƒ₁ may represent a function associated with the offset oₜ and the predetermined area area₁. For example, if the offset indicates that the time slot t is the first one in the predetermined time period, then β may be set to 0 (i.e., the lower bound of the area, or a relatively small value in the area, such as 0.01 or another value). If the offset indicates that the time slot t is not the first one in the predetermined time period, then β may be set to 1 (i.e., the upper bound of the area, or a relatively large value in the area, such as 0.99 or another value). In another example, β may increase with the offset within the area, for example, in proportional to the offset.

It is to be understood that the above paragraph just provides example values for the weight, alternatively and/or in addition, may be set to 0.5 or another value if the time slot is not the first one in the time period. With these implementations, the weight may be determined in easy and effect way, which may be helpful in learning more knowledge about the most recent sample data at the beginning of the time period.

In implementations of the present disclosure, the historical gradient information may be related to the accumulated gradient information for historical time slots before the time slot. For example, vₜ₋₁ may be determined based on historical gradient information for the respective historical time slots [1, t−1] before the time slot t, and the respective gradient information for the respective historical time slots [1, t−1] may be determined based on the above Formula 1. In order to determine the historical gradient information, respective gradient information may be determined based on respective historical sample data for the group of historical time slots before the time slot, and then the historical gradient information may be acquired based on the respective historical gradient information.

Here, the historical sample data for historical time slot(s) before the time slot is used to determine the historical gradient information. Specifically, the historical sample data for the time slot t is determined from the historical sample data for the historical time slots [1, t−1]. If the time slot t is the first time slot in the time period, then no historical time slot exists before the time slot t; and if the time slot t is the second time slot or subsequent time slot in the time period, then historical sample data for the historical time slots [1, t−1] may be used to determine the historical gradient information for the time slot t.

In implementations of the present disclosure, the historical gradient information may be determined in an iteration way. Specifically, in order to acquire the historical gradient information, respective squares of respective gradient information associated with respective historical time slots in the group of historical time slots may be determined, and then the historical gradient information may be determined based on a sum of the respective squares. For example, the historical gradient information for the time slot t+1 may be determined based on the following Formula 3.1:

vₜ=β·vₜ₋₁+gₜ² Formula 3.1

In this Formula, gₜ² represents a square of the gradient information gₜ (as determined in Formula 1), and vₜ₋₁ represents the historical gradient information for the time slot t. Here, β represents the same meaning as that in the Formula 2, where β is determined based on whether the time slot t is the first one in the time period. In one example, β=0 (or a relatively small value) when the time slot t is the first one; and β=1 (or a relative great value) when the time slot t is not the first one. Similarly, the historical gradient information for the time slot t may be determined based on the following Formula 3.2:

vₜ₋₁=β·v₍ₜ₋₁₎₋₁+gₜ₋₁² Formula 3.2

As this point, the historical gradient information may be determined in the iteration way, and thus the step size as determined in Formula 2.1 is also determined in the iteration way. With these implementations, the determination of the step size is converted into mathematics operations and thus the step size may be determined in a simple and effective way.

It is to be understood that the group of historical time slots may be within the current time period. In other words, during the current time period, sample data related to historical time slots within a previous time period before the current time period is excluded from determining the step size. Therefore, importance of the most recent data within the current time period is emphasized in updating the prediction model, and thus the prediction model may accurately reflect a trend of the continuously changing situation in the recommendation system.

In implementations of the present disclosure, the function ƒ( ) in Formula 2.1 may be defined in various ways. For example, Formula 2.1 may be refined into the following Formula 4:

$${Δ}_{t} = f ( β \cdot {v}_{t - 1} , {g}_{t} ) = - \frac{η}{\sqrt{{v}_{t} + ϵ}} \cdot {g}_{t} \qquad Formula 4$$

In this formula, an intermediate parameter vₜ (which is associated with the time slot t) may be determined based on the gradient information and a weighted historical gradient information that is determined based on the historical gradient information and the weight. Specifically, vₜ may be determined in the iteration way according to Formula 3.1 and then the step size may be determined based on the intermediate parameter vₜ and the gradient information gₜ. In other words, the intermediate parameter vₜ for the current time slot t may be determined based on the historical gradient information vₜ₋₁ for the current time slot t. Then, the intermediate parameter vₜ for the current time slot t may work as a historical gradient information for a next time slot t+1. η represents a learning rate for the prediction model. With these implementations, the intermediate parameter for the previous time slot t−1 may be reused in the time slot t, and thus the computation complexity for determining the step size may be reduced.

In implementations of the present disclosure, the intermediate parameter vₜ may be determined on the Formula 3.1, and thus Formula 4 may be converted into Formula 5:

$${Δ}_{t} = f ( β \cdot {v}_{t - 1} , {g}_{t} ) = - \frac{η}{\sqrt{{v}_{t} + ϵ}} \cdot {g}_{t} = - \frac{η}{\sqrt{β \cdot {v}_{t - 1} + {g}_{t}^{2} + ϵ}} \cdot {g}_{t} \qquad Formula 5$$

In this formula, Δₜ represents the step size for updating the parameter of the prediction model during the time slot t. vₜ₋₁ represents the historical gradient information associated with the group of time slots before the time slot t, and here vₜ₋₁ may be determined in the iteration way based on the respective sample data in the respective time slot(s) in the time period. gₜ represents the gradient information for the time slot t, and it may be determined based on Formula 1. ε represents a constant epsilon value for ensuring that the denominator portion in Formula 5 will not be zero. β represents the weight for the historical gradient information, and it may be determined on the offset of the time slot t in the time period (i.e., whether the time slot t is the first one of the time period). With these implementations, the step size Δₜ for updating the prediction model may be controlled by the offset of the time slot. Therefore, the prediction model may be updated toward a direction that provides more accurate prediction in the newly occurred situation.

In implementations of the present disclosure, Formula 5 may be modified in various ways. For example, the symbol ε may have a fixed value that is selected from an area of, for example, [10⁻⁶, 1] (or another area such as [10⁻⁵, 1] or [10⁻⁵, 0.5], and the like). In another example, the symbol ε may work as a dynamic attenuation factor for the intermediate parameter based on the offset. Specifically, the E may be determined based on the following Formula 6:

ε=ƒ₂(oₜ,area₂) Formula 6

In this formula, ε represents an attenuation factor that is selected from a predefined area (represented as area₂) based on the offset oₜ of the time slot t, and ƒ₂( ) represents a function associated with oₜ and area₂. At this point, the step size may be determined based on the gradient information and the attenuated intermediate parameter that is determined based on the intermediate parameter and the attenuation factor. Formula 5 may be converted into Formula 7 based on Formula 6, and all symbols have the same meaning as those in the previous formulas:

$${Δ}_{t} = - \frac{η}{\sqrt{{f}_{1} ( {o}_{t} , {area}_{1} ) \cdot {v}_{t - 1} + {g}_{t}^{2} + {f}_{2} ( {o}_{t} , {area}_{2} )}} \cdot {g}_{t} \qquad Formula 7$$

With these implementations, the step size for updating the prediction model depends on the offset oₜ. At this point, importance of the historical sample data may be decreased during the training procedure within the time slot t, and thus the importance of the recent sample data may be increased during the training procedure within the time slot t. Therefore, the step size may be determined toward a direction that matches the recent sample data in a better way.

In implementations of the present disclosure, once the step size is determined, the step size may be used to update the parameter(s) of the prediction model. Specifically, the prediction model may be updated according to Formula 8:

Wₜ₊₁=Wₜ+Δₜ Formula 8

In this formula, Wₜ represents the parameter(s) the prediction model for the time slot t, and Δₜ represents the step size for updating the parameter of the prediction model during the time slot t, Wₜ₊₁ represents the updated parameter(s) of the prediction model (such as the weight(s) for the machine learning model, and these weight(s) may work as the parameter(s) for the time slot t+1). With these implementations, the parameter of the prediction model may be updated by the recent sample data toward a direction that matches the newly occurred situation in a better way, and thus the updated prediction model may work well in the newly occurred situation.

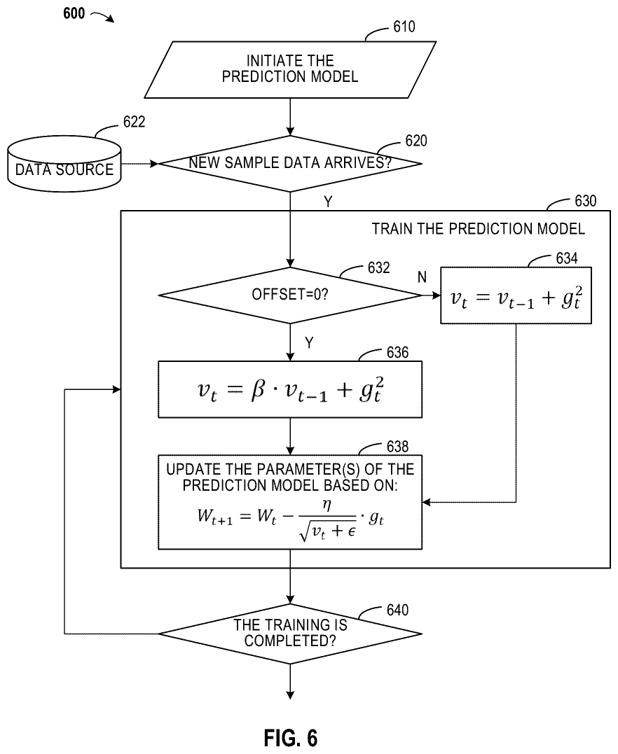

The preceding paragraphs have provided details for individual steps in the prediction model management. Hereinafter, referring to FIG. 6 for a training procedure by considering the offset in updating the prediction model. FIG. 6 illustrates an example flowchart for a method 600 for updating a prediction model according to implementations of the present disclosure. As illustrated in FIG. 6, at a block 610, the prediction model may be initiated. For example, the parameter(s) of the prediction model may be set to initial value(s). Alternatively and/or in addition, the parameter(s) may be set to partially optimized value(s). At a block 620, new sample data may be retrieved from a data source 622 for storing the newly collected sample data. If new sample data arrives, the method 600 may proceed to a block 630 for training the prediction model; else if no new sample data arrives, then the method 600 may wait until new sample data arrives.

Multiple steps may be implemented in the block 630, first, an offset related to the sample data may be determined at a block 632, and then a corresponding branch may be selected based on the determined offset. If the determined offset equals to zero (i.e., the sample data is related to the first time slot in the time period), then the method 600 may proceed to a block 636 and thus the step size may be determined based on the intermediate parameter vₜ, which depends on the weight β, the historical gradient information vₜ₋₁, and the gradient information gₜ. Here, the weight β is determined by the offset, and the weight β may be set to zero or a relatively small value near zero. If the offset does not equal to zero (i.e., the sample data is not related to the first time slot in the time period), then the method 600 may proceed to a block 634. At this point, the step size may be determined based on the intermediate parameter vₜ, which depends on both of the historical gradient information vₜ₋₁ and the gradient information gₜ. In this way, in each time period, impacts of the historical sample data is decreased by the weight β at the beginning of the time period, therefore the step size may consider more impacts of the recent sample data within the time period.

Further, the parameter(s) of the prediction model may be updated based on the determined step size according to the back propagation. At a block 640, if the training is completed (for example, the training procedure reaches a predetermined convergence condition), then the training procedure may end. If the training is not completed, then the method 600 may repeat steps in the block 630 until the predetermined convergence condition is met. Although the preceding paragraphs have provided details for determining the step size by individual sample data related to each time slot, each time slot may involve a group of sample data, and then the group of sample data may work as a batch for training the prediction model. Here, the prediction model may be updated in the iteration way in multiple batches toward an optimized direction effectively.

Once the training procedure ends, new data (for example, including only the data portion as shown in FIG. 4) may be inputted into the prediction model, and thus the prediction model may output a prediction for the new data. For example, if the prediction model is trained to learn whether a user will buy a camera product based on the historical sample, then the prediction model will output a probability that a certain user buys a certain camera.

With implementations of the present disclosure, the second order momentum of the prediction model may be reset in a periodic pattern, which shapes the optimizer's effective learning rate into cosine annealing restart kind. Further, the past local optima may be dropped with the reset. After that, the converge and generalization of the prediction model may be better fit to the recent data distribution, especially the yesterday's dumped data snapshot. Meanwhile, even if every day's data snapshot is not fully shuffled, the optimizer will not be significantly overfitting the last batches of training data (e.g., the training data within 23:00-24:00) as the effective learning rate decays fast to the end of day.

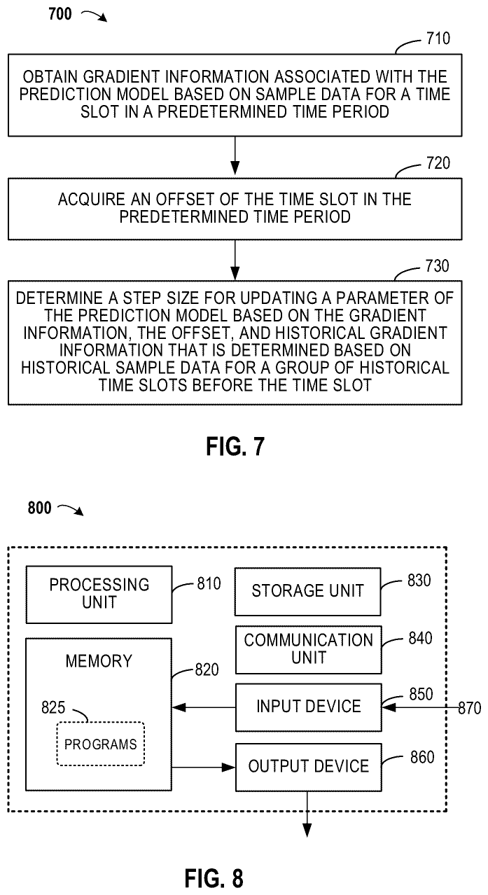

The above paragraphs have described details for the feature management. According to implementations of the present disclosure, a method is provided for feature management. Reference will be made to FIG. 7 for more details about the method, where FIG. 7 illustrates an example flowchart of a method 700 for managing a prediction model according to implementations of the present disclosure. At a block 710, gradient information associated with the prediction model is obtained based on sample data for a time slot in a predetermined time period. At a block 720, an offset of the time slot in the predetermined time period is obtained. At a block 730, a step size is determined for updating a parameter of the prediction model based on the gradient information, the offset, and historical gradient information that is determined based on historical sample data for a group of historical time slots before the time slot.

In implementations of the present disclosure, determining the step size comprises: determine a weight for the historical gradient information based on the offset; and generating the step size based on the gradient information, the historical gradient information, and the weight for the historical gradient information.

In implementations of the present disclosure, the weight is within a predefined area and increases with the offset.

In implementations of the present disclosure, generating the step size comprises: determining an intermediate parameter associated with the time slot based on the gradient information and a weighted historical gradient information that is determined based on the historical gradient information and the weight; and creating the step size based on the intermediate parameter and the gradient information.

In implementations of the present disclosure, creating the step size comprises: obtaining an attenuation factor for the intermediate parameter based on the offset; and determining the step size based on the gradient information and an attenuated intermediate parameter that is determined based on the intermediate parameter and the attenuation factor.

In implementations of the present disclosure, obtaining the gradient information comprises: obtaining a prediction for a label portion in the sample data based on a data portion in the sample data and the prediction model; determining a loss between the prediction for the label portion and the label portion; and acquiring the gradient information based on a gradient of the loss and the parameter of the prediction model.

In implementations of the present disclosure, the data portion represents features associated with a user and an object, the label portion represents an event between the user and the object, and the predetermined time period has a length of one or more days.

In implementations of the present disclosure, the method further comprises: determining the historical gradient information by: obtaining respective gradient information based on respective historical sample data for the group of historical time slots before the time slot; and acquiring the historical gradient information based on the obtained respective gradient information.

In implementations of the present disclosure, acquiring the historical gradient information comprises: determining respective squares of respective gradient information associated with the respective historical time slots in the group of historical time slots, the group of historical time slots being within the predefined time period; and determining the historical gradient information based on a sum of the respective squares.

In implementations of the present disclosure, the method further comprises: updating the parameter of the prediction model with the step size.

According to implementations of the present disclosure, an apparatus is provided for prediction model management. The apparatus comprises: an obtaining unit, being configured for obtaining gradient information associated with the prediction model based on sample data for a time slot in a predetermined time period; an acquiring unit, being configured for acquiring an offset of the time slot in the predetermined time period; and a determining unit, being configured for determining a step size for updating a parameter of the prediction model based on the gradient information, the offset, and historical gradient information that is determined based on historical sample data for a group of historical time slots before the time slot. Further, the apparatus may comprise other units for implementing other steps in the method 700.

According to implementations of the present disclosure, an electronic device is provided for implementing the method 700. The electronic device comprises: a computer processor coupled to a computer-readable memory unit, the memory unit comprising instructions that when executed by the computer processor implements a method for managing a prediction model. The method comprises: obtaining gradient information associated with the prediction model based on sample data for a time slot in a predetermined time period; acquiring an offset of the time slot in the predetermined time period; and determining a step size for updating a parameter of the prediction model based on the gradient information, the offset, and historical gradient information that is determined based on historical sample data for a group of historical time slots before the time slot.

In implementations of the present disclosure, determining the step size comprises: determine a weight for the historical gradient information based on the offset; and generating the step size based on the gradient information, the historical gradient information, and the weight for the historical gradient information.

In implementations of the present disclosure, the weight is within a predefined area and increases with the offset.

In implementations of the present disclosure, generating the step size comprises: determining an intermediate parameter associated with the time slot based on the gradient information and a weighted historical gradient information that is determined based on the historical gradient information and the weight; and creating the step size based on the intermediate parameter and the gradient information.

In implementations of the present disclosure, creating the step size comprises: obtaining an attenuation factor for the intermediate parameter based on the offset; and determining the step size based on the gradient information and an attenuated intermediate parameter that is determined based on the intermediate parameter and the attenuation factor.

In implementations of the present disclosure, obtaining the gradient information comprises: obtaining a prediction for a label portion in the sample data based on a data portion in the sample data and the prediction model; determining a loss between the prediction for the label portion and the label portion; and acquiring the gradient information based on a gradient of the loss and the parameter of the prediction model.

In implementations of the present disclosure, the data portion represents features associated with a user and an object, the label portion represents an event between the user and the object, and the predetermined time period has a length of one or more days.

In implementations of the present disclosure, the method further comprises determining the historical gradient information by: obtaining respective gradient information based on respective historical sample data for the group of historical time slots before the time slot; and acquiring the historical gradient information based on the obtained respective gradient information.

In implementations of the present disclosure, acquiring the historical gradient information comprises: determining respective squares of respective gradient information associated with the respective historical time slots in the group of historical time slots, the group of historical time slots being within the predefined time period; and determining the historical gradient information based on a sum of the respective squares.

In implementations of the present disclosure, the method further comprises: updating the parameter of the prediction model with the step size.

FIG. 8 illustrates a block diagram of a computing device 800 in which various implementations of the present disclosure can be implemented. It would be appreciated that the computing device 800 shown in FIG. 8 is merely for purpose of illustration, without suggesting any limitation to the functions and scopes of the present disclosure in any manner. The computing device 800 may be used to implement the above method 700 in implementations of the present disclosure. As shown in FIG. 8, the computing device 800 may be a general-purpose computing device. The computing device 800 may at least comprise one or more processors or processing units 810, a memory 820, a storage unit 830, one or more communication units 840, one or more input devices 850, and one or more output devices 860.

The processing unit 810 may be a physical or virtual processor and can implement various processes based on programs stored in the memory 820. In a multi-processor system, multiple processing units execute computer executable instructions in parallel so as to improve the parallel processing capability of the computing device 800. The processing unit 810 may also be referred to as a central processing unit (CPU), a microprocessor, a controller, or a microcontroller.

The computing device 800 typically includes various computer storage medium. Such medium can be any medium accessible by the computing device 800, including, but not limited to, volatile and non-volatile medium, or detachable and non-detachable medium. The memory 820 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 830 may be any detachable or non-detachable medium and may include a machine-readable medium such as a memory, flash memory drive, magnetic disk, or another other media, which can be used for storing information and/or data and can be accessed in the computing device 800.

The computing device 800 may further include additional detachable/non-detachable, volatile/non-volatile memory medium. Although not shown in FIG. 8, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 840 communicates with a further computing device via the communication medium. In addition, the functions of the components in the computing device 800 can be implemented by a single computing cluster or multiple computing machines that can communicate via communication connections. Therefore, the computing device 800 can operate in a networked environment using a logical connection with one or more other servers, networked personal computers (PCs) or further general network nodes.

The input device 850 may be one or more of a variety of input devices, such as a mouse, keyboard, tracking ball, voice-input device, and the like. The output device 860 may be one or more of a variety of output devices, such as a display, loudspeaker, printer, and the like. By means of the communication unit 840, the computing device 800 can further communicate with one or more external devices (not shown) such as the storage devices and display device, with one or more devices enabling the user to interact with the computing device 800, or any devices (such as a network card, a modem, and the like) enabling the computing device 800 to communicate with one or more other computing devices, if required. Such communication can be performed via input/output (I/O) interfaces (not shown).

In some implementations, instead of being integrated in a single device, some, or all components of the computing device 800 may also be arranged in cloud computing architecture. In the cloud computing architecture, the components may be provided remotely and work together to implement the functionalities described in the present disclosure. In some implementations, cloud computing provides computing, software, data access and storage service, which will not require end users to be aware of the physical locations or configurations of the systems or hardware providing these services. In various implementations, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The functionalities described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Program code for carrying out the methods of the subject matter described herein may be written in any combination of one or more programming languages. The program code may be provided to a processor or controller of a general-purpose computer, special purpose computer, or other programmable data processing apparatus such that the program code, when executed by the processor or controller, causes the functions/operations specified in the flowcharts and/or block diagrams to be implemented. The program code may be executed entirely or partly on a machine, executed as a stand-alone software package partly on the machine, partly on a remote machine, or entirely on the remote machine or server.

In the context of this disclosure, a machine-readable medium may be any tangible medium that may contain or store a program for use by or in connection with an instruction execution system, apparatus, or device. The machine-readable medium may be a machine-readable signal medium or a machine-readable storage medium. A machine-readable medium may include but not limited to an electronic, magnetic, optical, electromagnetic, infrared, or semiconductor system, apparatus, or device, or any suitable combination of the foregoing. More specific examples of the machine-readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are illustrated in a particular order, this should not be understood as requiring that such operations are performed in the particular order shown or in sequential order, or that all illustrated operations are performed to achieve the desired results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular implementations. Certain features that are described in the context of separate implementations may also be implemented in combination in a single implementation. Rather, various features described in a single implementation may also be implemented in multiple implementations separately or in any suitable sub-combination.

Although the subject matter has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

From the foregoing, it will be appreciated that specific implementations of the presently disclosed technology have been described herein for purposes of illustration, but that various modifications may be made without deviating from the scope of the disclosure. Accordingly, the presently disclosed technology is not limited except as by the appended claims.

Implementations of the subject matter and the functional operations described in the present disclosure can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media, and memory devices, including by way of example semiconductor memory devices, e.g., EPROM, EEPROM, and flash memory devices. The processor and the memory can be supplemented by, or incorporated in, special purpose logic circuitry.

It is intended that the specification, together with the drawings, be considered exemplary only, where exemplary means an example. As used herein, the use of “or” is intended to include “and/or”, unless the context clearly indicates otherwise.

While the present disclosure contains many specifics, these should not be construed as limitations on the scope of any disclosure or of what may be claimed, but rather as descriptions of features that may be specific to particular implementations of particular disclosures. Certain features that are described in the present disclosure in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are illustrated in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations. Only a few implementations and examples are described and other implementations, enhancements and variations can be made based on what is described and illustrated in the present disclosure.

What is claimed is:

1. A method for managing a prediction model, comprising:
obtaining gradient information associated with the prediction model based on sample data for a time slot in a predetermined time period;
acquiring an offset of the time slot in the predetermined time period; and
determining a step size for updating a parameter of the prediction model based on the gradient information, the offset, and historical gradient information that is determined based on historical sample data for a group of historical time slots before the time slot.

2. The method according to claim 1, wherein determining the step size comprises:
determine a weight for the historical gradient information based on the offset; and
generating the step size based on the gradient information, the historical gradient information, and the weight for the historical gradient information.

3. The method according to claim 2, wherein the weight is within a predefined area and increases with the offset.

4. The method according to claim 2, wherein generating the step size comprises:
determining an intermediate parameter associated with the time slot based on the gradient information and a weighted historical gradient information that is determined based on the historical gradient information and the weight; and
creating the step size based on the intermediate parameter and the gradient information.

5. The method according to claim 4, wherein creating the step size comprises:
obtaining an attenuation factor for the intermediate parameter based on the offset; and
determining the step size based on the gradient information and an attenuated intermediate parameter that is determined based on the intermediate parameter and the attenuation factor.

6. The method according to claim 1, wherein obtaining the gradient information comprises:
obtaining a prediction for a label portion in the sample data based on a data portion in the sample data and the prediction model;
determining a loss between the prediction for the label portion and the label portion; and
acquiring the gradient information based on a gradient of the loss and the parameter of the prediction model.

7. The method according to claim 6, wherein the data portion represents features associated with a user and an object, the label portion represents an event between the user and the object, and the predetermined time period has a length of one or more days.

8. The method according to claim 1, further comprising determining the historical gradient information by:
obtaining respective gradient information based on respective historical sample data for the group of historical time slots before the time slot; and
acquiring the historical gradient information based on the obtained respective gradient information.

9. The method according to claim 8, wherein acquiring the historical gradient information comprises:
determining respective squares of respective gradient information associated with the respective historical time slots in the group of historical time slots, the group of historical time slots being within the predefined time period; and
determining the historical gradient information based on a sum of the respective squares.

10. The method according to claim 1, further comprising: updating the parameter of the prediction model with the step size.

11. An electronic device, comprising a computer processor coupled to a computer-readable memory unit, the memory unit comprising instructions that when executed by the computer processor implements a method for managing a prediction model, the method comprising:
obtaining gradient information associated with the prediction model based on sample data for a time slot in a predetermined time period;
acquiring an offset of the time slot in the predetermined time period; and
determining a step size for updating a parameter of the prediction model based on the gradient information, the offset, and historical gradient information that is determined based on historical sample data for a group of historical time slots before the time slot.

12. The device according to claim 11, wherein determining the step size comprises:
determine a weight for the historical gradient information based on the offset; and
generating the step size based on the gradient information, the historical gradient information, and the weight for the historical gradient information.

13. The device according to claim 12, wherein the weight is within a predefined area and increases with the offset.

14. The device according to claim 12, wherein generating the step size comprises:
determining an intermediate parameter associated with the time slot based on the gradient information and a weighted historical gradient information that is determined based on the historical gradient information and the weight; and
creating the step size based on the intermediate parameter and the gradient information.

15. The device according to claim 14, wherein creating the step size comprises:
obtaining an attenuation factor for the intermediate parameter based on the offset; and
determining the step size based on the gradient information and an attenuated intermediate parameter that is determined based on the intermediate parameter and the attenuation factor.

16. The device according to claim 11, wherein obtaining the gradient information comprises:
obtaining a prediction for a label portion in the sample data based on a data portion in the sample data and the prediction model;
determining a loss between the prediction for the label portion and the label portion; and
acquiring the gradient information based on a gradient of the loss and the parameter of the prediction model.

17. The device according to claim 16, wherein the data portion represents features associated with a user and an object, the label portion represents an event between the user and the object, and the predetermined time period has a length of one or more days, and the method further comprises: updating the parameter of the prediction model with the step size.

18. The device according to claim 11, wherein the method further comprises determining the historical gradient information by:
obtaining respective gradient information based on respective historical sample data for the group of historical time slots before the time slot; and
acquiring the historical gradient information based on the obtained respective gradient information.

19. The device according to claim 18, wherein acquiring the historical gradient information comprises:
determining respective squares of respective gradient information associated with the respective historical time slots in the group of historical time slots, the group of historical time slots being within the predefined time period; and
determining the historical gradient information based on a sum of the respective squares.

20. A non-transitory computer program product, the non-transitory computer program product comprising a computer readable storage medium having program instructions embodied therewith, the program instructions executable by an electronic device to cause the electronic device to perform a method for managing a prediction model, the method comprising:
obtaining gradient information associated with the prediction model based on sample data for a time slot in a predetermined time period;
acquiring an offset of the time slot in the predetermined time period; and
determining a step size for updating a parameter of the prediction model based on the gradient information, the offset, and historical gradient information that is determined based on historical sample data for a group of historical time slots before the time slot.
